(19) United States
(12) Patent Application Publication
(10) Pub. No.: US 2010/0201530 A1
(43) Pub. Date: Aug. 12, 2010

(54) System And Method For Carbon Monoxide Detection And Warning

(76) Inventor: James David Wende, Hilliard, OH (US)

Correspondence Address: RONALD J. KOCH, 698 MORRISON RD., SUITE B, COLUMBUS, OH, 43213, US

(21) Appl. No.: 12/370,525

(22) Filed: Feb. 12, 2009

(51) Int. Cl. G08B 17/10; G08B 3/10

(52) U.S. Cl. 340/632; 340/384.1

(57) ABSTRACT

A system and method for the detection and alerting of the presence of carbon monoxide having a system 50 including, a CO detector component 51, a processing component 52, and a power supply component 53 for powering the CO detector and processing components 51, 52; the CO detector component supplies an electrical output signal 53 proportional to a measured level of CO; the processing component performs analog to digital conversion of the electrical output signal 53, generates a first digital audio signal by performing analog to digital conversion of a first analog audio signal 54, generates a second digital audio signal relative to the electrical output signal 53; generates a third digital audio signal by combining the first and second digital audio signals; and generates a second analog audio signal 55 by performing digital to analog conversion of the third digital audio signal.

### CROSS REFERENCE TO RELATED APPLICATIONS

Not Applicable

### FEDERALLY SPONSORED RESEARCH

Not Applicable

### SEQUENCE LISTING, TABLE, OR COMPUTER PROGRAM COMPACT DISK APPENDIX

### Not Applicable

### CLAIM OF PRIORITY BASED ON COPENDING APPLICATION

Not Applicable

### BACKGROUND AND SUMMARY

Conventional carbon monoxide (CO) detectors utilize audio warnings or indicator lights. However, such systems are problematic when employed in the cockpit of an aircraft (especially small aircraft) for several reasons. An audio warning (external to headphones worn by the pilot) is not easily detectible due to the extreme ambient noise present. Additionally, the pilot's attention is often focused on the instrumentation panels and viewing the surroundings so an indicator light alone is insufficient.

The present invention overcomes these disadvantages as well as others apparent to those of skill in the art by providing a method for the detection and alerting of the presence of a gas comprising the steps of generating a first audio signal according to a measured level of the gas, and combining the first audio signal with the audio output signal of the cockpit radio. One of skill in the art will appreciate that various gases may be detected instead of or in addition to CO (carbon monoxide) utilizing other sensors and necessary interface circuitry.

### BRIEF DESCRIPTION OF THE DRAWINGS

FIG. 1 depicts a block diagram of one embodiment of the invention.

FIG. 2 depicts a block diagram of one embodiment of the invention.

FIG. 3 depicts a schematic diagram of a representative measuring circuit for a CO detector.

FIG. 4 depicts a block diagram of one embodiment of the invention.

FIG. 5 depicts a block diagram of an on/off switch in accordance with one embodiment of the invention.

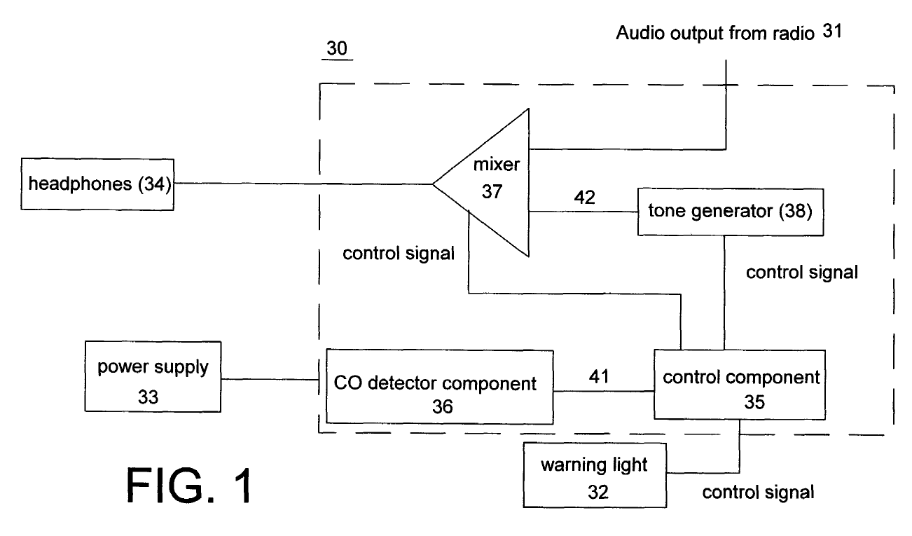

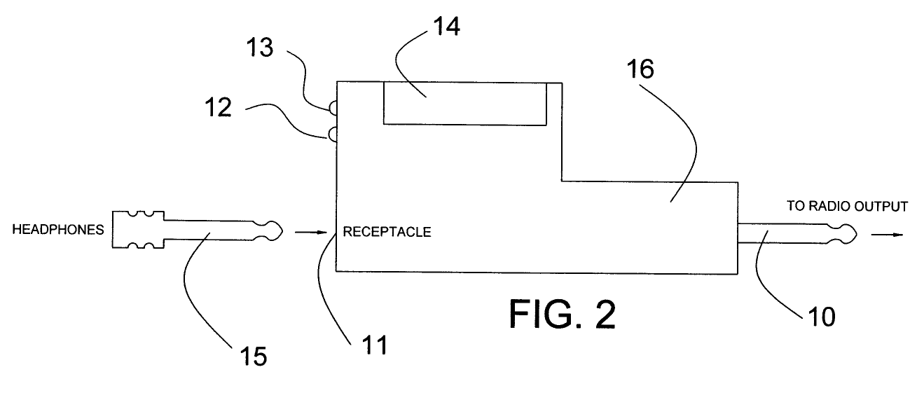

### DETAILED DESCRIPTION

A system and method for the detection and alerting of the presence of carbon monoxide comprises a system 50 having,

a CO detector component 5 1, a processing component 52, and a power supply component 53 for powering the CO detector and processing components 51, 52; the CO detector component supplies an electrical output signal 53 proportional to a measured level of CO; the processing component performs analog to digital conversion of the electrical output signal 53, generates a first digital audio signal by performing analog to digital conversion of a first analog audio signal 54, generates a second digital audio signal relative to the electrical output signal 53; generates a third digital audio signal by combining the first and second digital audio signals; and generates a second analog audio signal 55 by performing digital to analog conversion of the third digital audio signal.

One of skill in the art will appreciate that such CO detector components usually require interface circuitry and input biasing for proper measurement and amplification of CO output signal.

First analog audio signal 54 originates from the audio (headphone) output of the radio in the cockpit of an aircraft. However, the same is suitable for many other audio output sources. The second digital audio signal is generated proportional to electrical output signal 53. This can be a pre determined level based on a threshold level of CO detected or can be based on a lookup table.

In one embodiment, the second and third digital audio signals exist within computer memory. They are combined so as to create a perceivable signal (after digital to audio conversion) in addition to the radio output so that the pilot will hear the radio output but will also hear the tone. The tone will alert the pilot about the CO level.

In one embodiment, the second signal is a tone. However, other noises may be used provided they do not prevent the pilot from hearing the radio output. In one embodiment, an audio amplifier component 56 is provided to boost the analog audio signal. It is also powered by power supply 53. This feature is only essential in environments requiring increased audio levels.

In one embodiment, an on/off switch 57 is provided for the purpose of automatically entering a power saving mode when the unit is not connected to a radio. This function can be accomplished either mechanically, electrically, or a combination of the two. For example, jack plug 10 can be replaced by a female jack in the body of the unit and an audio cable having male jacks on both ends. A mechanical on/off switch can be disposed inside of the housing so that it is engaged upon the insertion of a male jack end, the other end being inserted into the radio output jack. Additionally, the on off switch can be a manual switch 13 that is not operable to disengage the power in the absence of the signal. In this embodiment, the user simply actuates the switch.

In one embodiment, the CO detector, interface circuitry, and processing are all in a self contained enclosure 16. The enclosure is preferably sized so as to be self supporting when radio jack 10 is inserted into the output jack of a radio. However, this feature is not essential. Other sized housings can be used.

In one embodiment, a system for the detection and alerting of the presence of carbon monoxide comprises, within an enclosure, a carbon monoxide detector component 36 having an electrical output signal 41 proportional to the level of carbon monoxide detected, a control component 35, in electrical communication with the carbon monoxide detector component 36, for generating a warning signal 42 corresponding to the electrical output signal, a jack plug 10 for connecting to the output jack of a radio, a jack 11 for connecting to audio headphones 15, and a power supply 33. A small DC battery (e.g. AA size) is preferred but other power sources (e.g. DC source or AC source with rectifier and transformer) may be used.

As will be appreciated by one of skill in the art, such power supplies can include, if necessary, a voltage regulator chip, capacitors, and transformers (for an AC source).

The CO detector component 36 provides a signal, such as an output current proportional to the detected level of CO (in parts per million—ppm). One of skill in the art would appreciate known components for detecting CO. Such components are usually combined with necessary interface/control circuitry (control component 35) for supplying a signal upon a certain level (pre set or adjustable) of CO detected. A measuring circuit interfaces with the detector element and generates a reference signal which in turn is used to drive the warning indicators such as audio tones and warning lights.

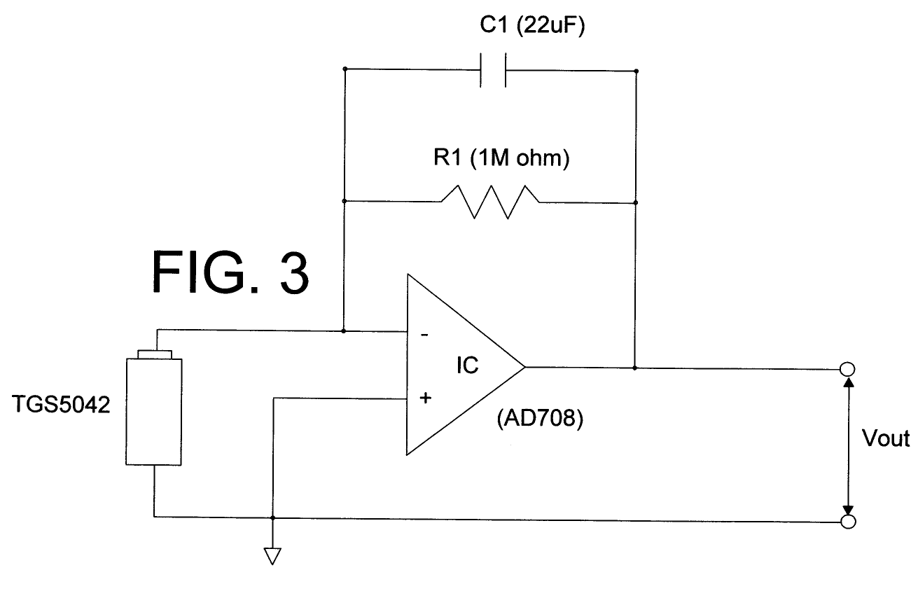

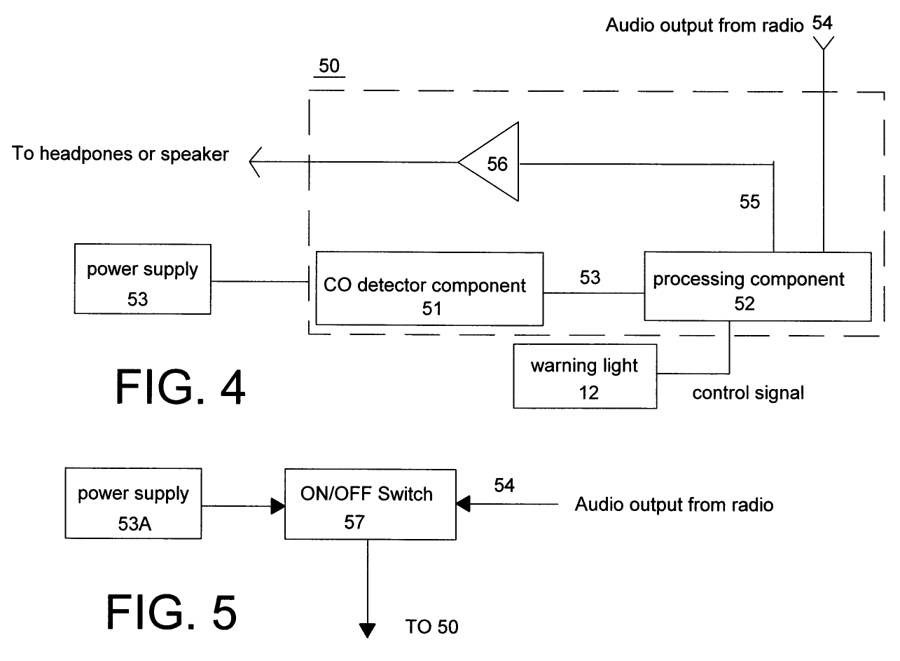

Various CO detector components may be used provided they are small enough to be implemented within a relatively small enclosure. For example, the “TGS 5042” by “Figaro Engineering, Inc.” (www.figaro.co.jp). This CO detector component is about the size of a AA battery and is thus ideally sized. The unit provides a small current output proportional to the level of CO detected. The measuring circuit (depicted in FIG. 3) yields an output voltage proportion to CO levels. This voltage may then be used to trigger various alarms.

Another suitable sensor is the “MQ307A CO GAS SENSOR” (http://www.hwsensor.com). The MQ307A is a tin dioxide semiconductor gas sensor. It uses a mini-bead type sensing element with a periodic temperature change operation method, high sensitivity, selectively, and small effect from humidity.

In one embodiment, the a warning light 12 is used in addition to the audio signal to alert the user. The warning light is not essential.

One of skill in the art will appreciate that control component 35 can be realized in various ways (e.g. analog circuitry, digital signal processor, microprocessor, field-programmable gate array (FPGA), or a combination of the forgoing) and that tone generator 38 and Audio mixer 37 can be stand alone or integrated, analog or digital.

In one embodiment, the threshold CO level is user adjustable. One of skill in the art will appreciate that the calibration can be realized for analog circuits (potentiometers) and/or digital processors (lookup tables or bias circuitry).

What is claimed is:

1. A method for the detection and alerting of the presence of a gas comprising the steps of: generating a first audio signal according to a measured level of said gas, and combining said first audio signal with the audio output signal of a radio.

2. A method for the detection and alerting of the presence of carbon monoxide comprising the steps of:
providing a system having,
a CO detector component,
a processing component,
a power supply component for powering said CO detector component and said processing component;
said CO detector component supplying an electrical output signal proportional to a measured level of CO;
said processing component performing analog to digital conversion of said electrical output signal;
said processing component generating a first digital audio signal by performing analog to digital conversion of a first analog audio signal;
said processing component generating a second digital audio signal relative to said electrical output signal;
said processing component generating a third digital audio signal by combining said first and second digital audio signals;
said processing component generating a second analog audio signal by performing digital to analog conversion of said third digital audio signal.

3. The method of claim 2 further comprising the step of:
said system further comprising an audio amplifier component;
said power supply component capable of powering said audio amplifier component;
said audio amplifier component amplifying said second analog audio signal.

4. The method of claim 3 further comprising the step of:
said audio amplifier component amplifying said second analog audio signal to a level suitable for a loud speaker.

5. The method of claim 3 further comprising the step of:
said audio amplifier component amplifying said second analog audio signal to a level suitable for audio headphones.

6. The method of claim 2 further comprising the step of:
said system further comprising an on/off switch in electrical communication with said power supply and said first analog audio signal;
de-energizing said system in the absence of said first analog audio signal.

7. A system for the detection and alerting of the presence of carbon monoxide comprising:
a CO detector component capable of supplying an electrical output signal proportional to a measured level of CO;
a processing component;
a power supply component for powering said CO detector component and said processing component;
said processing component having a computer processor and memory sufficient to perform the steps of,
performing analog to digital conversion of said electrical output signal,
generating a first digital audio signal by performing analog to digital conversion of a first analog audio signal,
generating a second digital audio signal relative to said electrical output signal,
generating a third digital audio signal by combining said first and second digital audio signals,
generating a second analog audio signal by performing digital to analog conversion of said third digital audio signal.

8. The system of claim 7 further comprising:
an audio amplifier component for amplifying said second analog audio signal;
said power supply component capable of powering said audio amplifier component.

9. The system of claim 8 further comprising:
said audio amplifier component capable of amplifying said second analog audio signal to a level suitable for a loud speaker.

10. The system of claim 8 further comprising:
said audio amplifier component capable of amplifying said second analog audio signal to a level suitable for audio headphones.

11. The system of claim 7 further comprising:
an on/off switch in electrical communication with said power supply and said first analog audio signal;
wherein said power supply is de-energized in the absence of said first analog audio signal.

12. A system for the detection and alerting of the presence of a gas comprising:
within a self contained enclosure, a gas detector module and associated circuitry and power supply sufficient to generate an audio tone upon detection of a measured level of said gas, said audio tone being mixed with the audio output of a radio.

13. The system of claim 12 wherein said power supply is energized only when said system is in electrical communication with said audio output of a radio.

14. The system of claim 12 wherein said system is for use in the cockpit of an aircraft.

15. A system for the detection and alerting of the presence of carbon monoxide comprising:
within an enclosure,
a carbon monoxide detector component having an electrical output signal proportional to the level of carbon monoxide detected,
a control component, in electrical communication with said carbon monoxide detector component, for generating a warning signal corresponding to said electrical output signal,
a jack plug for connecting to the output jack of a radio,
a jack for connecting to audio headphones,
a power supply.

16. The system of claim 15 wherein said control component further comprises:
a measuring circuit for measuring said electrical output signal of said carbon monoxide detector component and generating a reference signal proportional thereto;
a processing component in electrical communication with said reference signal;
a tone generator in electrical communication with said processing component for generating an audio tone according to a pre selected value of said reference signal;
an audio mixer for mixing said audio tone with the output audio signal of a radio.

17. The system of claim 15 further comprising:
said warning signal comprises an light source in additional to said audio tone.

18. The system of claim 15 further comprising:
said control component having means for calibrating the threshold level of said electrical output signal whereby said warning signal can correspond to differing carbon monoxide levels.

19. The system of claim 15 further comprising:
said radio being an aircraft radio.

20. The system of claim 15 wherein said power supply comprises:
a AA battery cell, a DC source, or an AC source.

21. The system of claim 15 further comprising:
an on/off switch in electrical communication with said power supply and the audio output of a radio wherein said power supply is de-energized in the absence of said radio output.
